(19) United States
(12) Patent Application Publication
(10) Pub. No.: US 2007/0195784 A1
(43) Pub. Date: Aug. 23, 2007

(54) POWER SAVING SCHEME FOR NODES THAT ARE OUT OF RANGE OF A NETWORK

(75) Inventors: Vernon A. Allen, Fort Lauderdale, FL (US); Andric Oleg, West Palm Beach, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,281

(22) Filed: Feb. 22, 2006

(51) Int. Cl. H04L 12/56; H04L 12/28

(52) U.S. Cl. 370/395.2

(57) ABSTRACT

A power saving scheme for nodes (101) that are out of range of a network is provided herein. During operation when a node determines that it is out of range of a network it will switch to a “disconnected” mode of operation. In the “disconnected” mode the node will transmit a message on a semi-random interval (so as not to interfere continuously with a beaconing network once back in range), and then switch to receive mode for a short period of time (much less than a frame length). The transmitted message will inform any node that receives it that the transmitting node is currently disconnected from the network and include the MAC address of the disconnected node. The disconnected node will go into sleep mode after the short receive period.

### FIELD OF THE INVENTION

The present invention relates generally to power-saving techniques and in particular, to a power saving scheme for nodes that are out of range of a network.

### BACKGROUND OF THE INVENTION

Most ad-hoc networks operate with low power consumption. A node's battery life is optimized in the network by allowing the node to sleep for a majority of the time while connected to the network. However, once a node leaves the range of a network it begins to search for a network to join. In general a node will have to scan multiple channels to determine if a network is available which can take several seconds, and is very battery intensive. After scanning the node can go to sleep, but if the unit is asleep for a very long time it will take longer for the unit to rejoin the network once back in range. This lack of response time is unacceptable in a number of applications. Because of this, most nodes leaving the range of a network will exhaust battery power in a matter of days because it searches near continuously for a network to join. Therefore, a need exists for a power saving scheme for nodes that are out of range of a network that doesn't quickly exhaust battery power.

### BRIEF DESCRIPTION OF THE DRAWINGS

FIG. 1 is a block diagram of a network.

FIG. 2 is a block diagram of a node.

FIG. 3 is a flow chart showing operation of the node of FIG. 2.

### DETAILED DESCRIPTION OF THE DRAWINGS

In order to address the above-mentioned need, a power saving scheme for nodes that are out of range of a network is provided herein. During operation when a node determines that it is out of range of a network it will switch to a “disconnected” mode of operation. In the “disconnected” mode the node will transmit a message on a semi-random interval (so as not to interfere continuously with a beaconing network once back in range), and then switch to receive mode for a short period of time (much less than a frame length). The transmitted message will inform any node that receives it that the transmitting node is currently disconnected from the network and include the MAC address of the disconnected node. The disconnected node will go into sleep mode after the short receive period. Because the receive period is very short, the disconnected node will be in sleep mode a majority of the time, greatly increasing battery life.

The present invention encompasses a method for operating a node that is out of range of a network. The method comprises the steps of determining that the node is disconnected from a network, sending out a “disconnect” message, and immediately after sending the “disconnect” message, listening for an “in-range” message indicating that the node is in range of the network. When an “in-range” message is received association with the network takes place, otherwise the node powers down.

The present invention additionally encompasses an apparatus comprising a transmitter sending out a “disconnect” message when a node is disconnected from a network, a receiver for listening for an “in-range” message immediately after sending the “disconnect” message, wherein the “in-range” message indicates that the node is in range of the network, and logic circuitry associating with the network when an “in-range” message is received and powering down when an “in-range” message is not received.

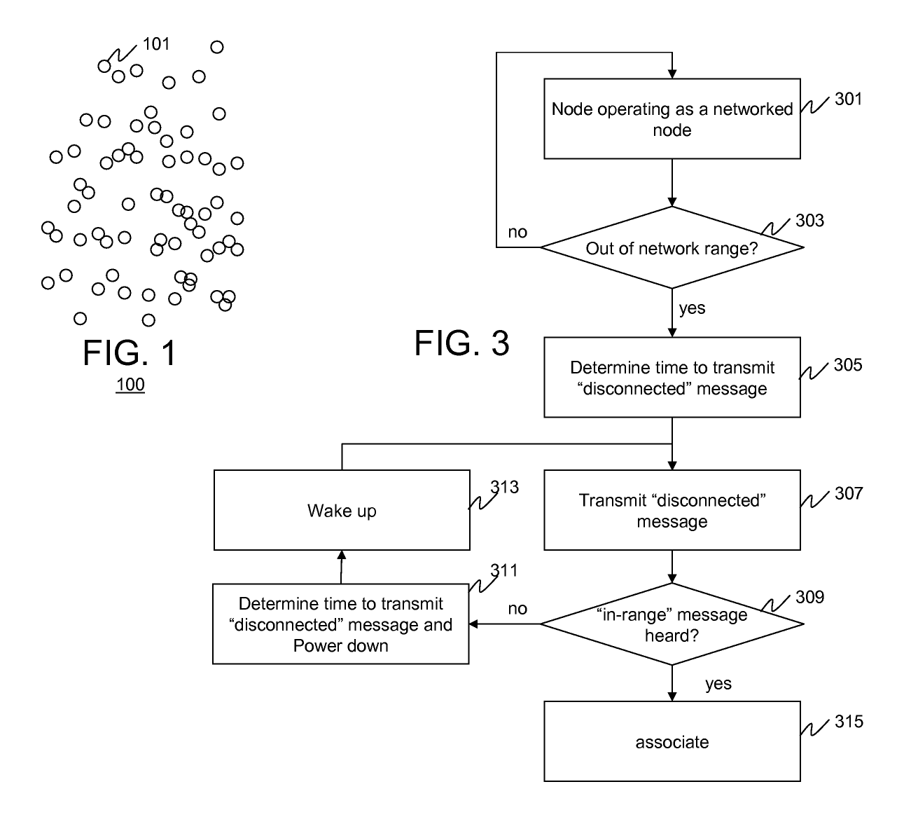

Turning now to the drawings, wherein like numerals designate like components, FIG. 1 illustrates network 100 in accordance with the preferred embodiment of the present invention. Network 100 preferably utilizes an ad-hoc network protocol defined by 802.15.3 Wireless Personal Area Networks for High Data Rates or IEEE 802.15.4 Low Rate Wireless Personal Area Networks. However one of ordinary skill in the art will recognize that other network protocols may be utilized without varying from the scope of the invention. For example, network 100 may utilize network protocols such as, but not limited to, Ad-hoc On Demand Distance Vector Routing (AODV), Dynamic Source Routing (DSR), Temporally-Ordered Routing Algorithm (TORA), Bluetooth™ standard (IEEE Standard 802.15.1), . . . , etc. As shown, network 100 includes a number of nodes 101 (only one labeled) that represent devices that communicate with each other through.

Nodes 101 can be transportable (mobile) or they can be fixed in a given place. Additionally, nodes 101 may be battery powered, or “plugged” into a power supply such as a standard 110 Volt A/C supply. Nodes 101 that are battery powered typically employ a power savings technique that allow nodes 101 to “sleep” a majority of the time. In contrast, nodes that are “plugged” into a power supply do not sleep because there is no need to save power in these nodes.

As one of ordinary skill in the art will recognize, for Ad-Hoc networks, data communication between nodes 101 occurs by firstly discovering intervening nodes that exist between a source and a destination node, and then relaying the data from the source node, through the intervening nodes, to the destination node. Thus, in order to be a part of network 100 (i.e., connected to network 100), a node will have to be in communication range of at least one other node that is part of network 100.

As discussed above, once a prior-art node leaves the range of all nodes 101, it begins to search for a network to join by intensively scanning for nodes within communication range. Because of this, most prior-art nodes leaving the range of a network will exhaust battery power in a matter of days because they search near continuously for a network to join. In order to address this issue, a specified message (“disconnected” message) will be transmitted that indicates a node is out of range and not part of network 100. In order to save battery power, the disconnected message is sent randomly, but preferably no more than once every 10 seconds. After sending the “disconnected” message, a node will listen for a response from any other node within range. In order to conserve battery power a node will listen for a time period much less than a frame length, and preferably less than 30 ms.

A node that is connected to the network and receives the “disconnected” message will immediately transmit an ‘in-range’ message directed to the MAC address included in the “disconnected” message. The ‘in-range’ message will trigger the disconnected node to switch into ‘Connecting’ mode and begin the standard association process. It should be noted that both the “disconnected” message and the “in-range” message comprise standard messaging designed to conform to the communication protocol being utilized. For example, for communication systems employing the IEEE 802.15.4 communication system protocol, both the “disconnected” and the “in-range” messages will comprise a frame control field, sequence number field, destination and source PAN identifier fields, destination and source address fields, payload field, and a check sequence field. The payload field would be specified for both “disconnected” and “in-range” messages to contain message-specific information.

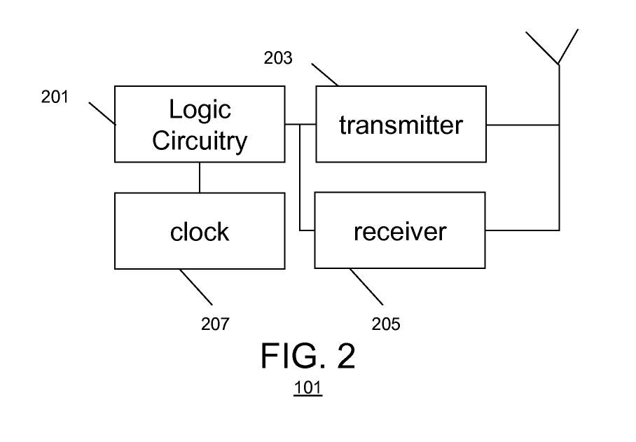

FIG. 2 is a block diagram of node 101 equipped enter a power-savings mode when disconnected from a network. As shown, node 101 comprises logic circuitry 201, transmitter 203, receiver 205, and clock 207. Although various forms for logic circuitry 201, transmitter 203, and receiver 205 are envisioned, in a preferred embodiment of the present invention node 101 is formed from a Freescale Inc. MC 13192 transceiver (transmitter 203 and receiver 205) coupled to a Motorola HC08 8-bit processor 201.

During operation, logic circuitry 201 determines that it is in range of other nodes (and thus connected to network 100) by periodically waking and listening to beacon transmissions from other nodes. In a similar manner, logic circuitry will instruct transmitter 203 to periodically broadcast a beacon to neighboring nodes when associated with network 100. When no beacon transmission is heard, logic circuitry 201 will assume that node 101 is out of range of network 100 and begin randomly transmitting a “disconnected” message. Logic circuitry 201 will determine an appropriate time to transmit the “disconnected” message, and will access clock 207 to determine the appropriate time. Additionally, logic circuitry 201 will determine which channel to transmit the “disconnected” message depending on the design of the system. For example, in a system designed for multiple channels a specific control channel is used for this message and nodes that monitor the channel placed at entry ways to detect disconnected nodes. If network 100 utilizes a single channel for transmissions then the disconnected node will use this channel to transmit the “disconnected” message.

Once logic circuitry 201 instructs transmitter 203 to transmit the “disconnected” message, logic circuitry 201 will access receiver 205 to determine if a an “in-range” message was received, and if not, logic circuitry 201 will instruct all components within node 101 to enter a power savings mode and power down for a specified period of time (e.g. 30 seconds). As discussed, the time period that node 101 listens for an in-range message is much shorter than a frame length, and is preferably less than 30 milliseconds.

FIG. 3 is a flow chart showing operation of the node of FIG. 2 that is out of range of a network. The logic flow begins at step 301 where node 101 is operating as a networked node. At step 303 logic circuitry 201 determines if node 101 is disconnected from the network. As discussed above, this is accomplished by determining that receiver 305 has failed to hear beacons from other network nodes, indicating that the node is out of communication range from all other networked nodes. If at step 303 it is determined that node 101 is out of network range, the logic flow continues to step 305, otherwise the logic flow returns to step 301. At step 305, logic circuitry 201 determines a time to transmit a “disconnected” message. As discussed above, the “disconnected” message transmit time is a random time, with preferably no less than 10 second existing between transmissions.

The logic flow continues to step 307 where the “disconnected” message is transmitted by transmitter 203. Logic circuitry then accesses receiver 205 to determine if an “in-range” message has been heard (step 309). As discussed above, immediately after sending the “disconnect” message, receiver 205 will listen for an in-range” message indicating that the node is in range of a network. The time period that receiver 205 will listen for the “in-range” message is much les than a frame period, and preferably less than 30 milliseconds.

Continuing, if at step 309, it is determined that an “in-range” message has been heard, the logic flow continues to step 315 where normal network association takes place by logic circuitry 201. If, however, it is determined that an “in-range” message has not been heard, the logic flow continues to step 311 where a time period to transmit the “disconnect” message is determined and logic circuitry 201 instructs components within node 101 to power down. As discussed above the disconnect message is sent out preferably no more than once every 10 seconds at a random time period. At step 311 logic circuitry 201 instructs components within node 101 to power up and the logic flow returns to step 307 where a “disconnected” message is again transmitted.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for operating a node that is out of range of a network, the method comprising the steps of:
determining that the node is disconnected from a network;
sending out a “disconnect” message that is not synchronized to any network;
immediately after sending the “disconnect” message, listening for an “in-range” message for a period of time shorter than a frame length, wherein the “disconnect” message indicates that the node is in range of the network;
associating with the network when an “in-range” message is received; and
powering down when an “in-range” message is not received.

2. The method of claim 1 wherein the step that the node is disconnected from the network comprises the step of determining that the node is out of communication range from all other networked nodes.

3. The method of claim 1 wherein the step of sending out the “disconnect” message comprises the step of sending out the “disconnect” message no more than once every 10 seconds.

4. The method of claim 3 wherein the step of sending out the “disconnect” message comprises the step of sending out the “disconnect” message at a random time period no more than once every 10 seconds.

5. The method of claim 4 wherein the step of listening for an “in-range” message comprises the step of listening for a time period much less than a frame period.

6. The method of claim 5 wherein the time period is less than 30 milliseconds.

7. The method of claim 1 wherein the step of sending out the “disconnect” message comprises the step of sending out the disconnect message at a random time period no more than once every 10 seconds.

8. The method of claim 1 wherein the step of listening for an “in-range” message comprises the step of listening for a time period much less than a frame period.

9. The method of claim 8 wherein the time period is less than 30 milliseconds.

10. An apparatus comprising:
a transmitter sending out a “disconnect” message when a node is disconnected from a network;
a receiver for listening for an “in-range” message immediately after sending the “disconnect” message, wherein the “in-range” message indicates that the node is in range of the network;
logic circuitry associating with the network when an “in-range” message is received and powering down when an “in-range” message is not received.

11. The apparatus of claim 10 wherein the node is disconnected from the network when the node is out of communication range from all other networked nodes.

12. The apparatus of claim 10 wherein the “disconnect” message is sent out no more than once every 10 seconds.

13. The apparatus of claim 12 wherein the disconnect message is sent at a random time period no more than once every 10 seconds.

14. The apparatus of claim 13 wherein the receiver listens for an “in-range” message for a time period much less than a frame period.

15. The apparatus of claim 14 wherein the time period is less than 30 milliseconds.

16. The apparatus of claim 10 wherein the “disconnect” message is sent at a random time period no more than once every 10 seconds.

17. The apparatus of claim 10 wherein the receiver listens for an “in-range” message for a time period much less than a frame period.

18. The apparatus of claim 17 wherein the time period is less than 30 milliseconds.
